(19) United States
(12) Patent Application Publication
(10) Pub. No.: US 2003/0144928 A1
(43) Pub. Date: Jul. 31, 2003

(54) Parts distribution managing system, parts distribution managing method and enclosed tag packed with parts

(75) Inventor: Ikuo Kawakami, Tokyo (JP)

Correspondence Address: ARENT FOX KINTNER PLOTKIN & KAHN, PLLC, 1050 Connecticut Avenue, N.W., Suite 400, Washington, DC, 20036-5339, US

(73) Assignee: HONDA GIKEN KOGYO KABUSHIKI KAISHA

(21) Appl. No.: 10/335,923

(22) Filed: Jan. 3, 2003

(30) Foreign Application Priority Data
Jan. 29, 2002 (JP) 2002-20444

(51) Int. Cl. G06F 17/60

(52) U.S. Cl. 705/29

(57) ABSTRACT

In the parts distribution managing system and the parts distribution managing method according to the present invention, an enclosed tag to be packed with parts, is issued. The enclosed tag has at least a delivery number corresponding to a set of parts delivered according to an order and a location number indicating a location where the set of parts should be received in the warehouse located at the receiving side. Further, packing specifications data including at least the delivery number and the location number are supplied to the receiving side. At the receiving side parts can be received in the warehouse using the enclosed tag and the packing specifications data, thus saving operators time and trouble. Further, when a location number in the packing specifications data does not indicate an empty location, a new enclosed tag may be re-issued for more flexible treatment. According to a preferred embodiment of the present invention, the enclosed tag further has a code indicating a location number. Further, at the receiving side locations in the warehouse are managed based on codes included in enclosed tags packed with parts. Thus, data of locations in the warehouse, are managed for each enclosed tag, using a code included in the tag, allowing quicker update of inventory data and allocation of parts before reception.

### FIELD OF THE INVENTION

The present invention relates to a parts-distribution managing system and a parts-distribution managing method for the sending side and the receiving side, which reduce a required amount of work at the sending side and the receiving side. Specifically, it relates to a parts-distribution managing system and a parts-distribution managing method in which locations for storing parts in a warehouse at the receiving side, are determined at the sending side.

### BACKGROUND OF THE INVENTION

Parts of vehicles, for example, are manufactured by a parts manufacturer, checked for quality assurance and the like by a brand manufacturer of vehicles and then sold via domestic and foreign sales hubs. The sales hubs order parts to the brand manufacturer of vehicles and then receive their ordered parts. The sales hubs temporarily keep in their warehouses the parts to be supplied to their customers including vehicle dealers and parts shops.

Conventionally, distribution of parts by the brand manufacturer of vehicles to the sales hubs has been managed in such a way as shown below. The brand manufacturer of vehicles packs parts with an enclosed tag and sends them to the sales hubs. The enclosed tag has a delivery number corresponding to the set of parts sent according to an order. Further, the brand manufacturer of vehicles creates package specifications data including the delivery number and other information on the package, and sends them to systems for the sales pubs.

At the sales hubs, data on an enclosed tag and package specifications data are compared with each other, for example, using the delivery number as key. After the comparison has been successfully completed, a receiving list is created and a management tag for the warehouse is created and issued by the system. The management tag has information on locations where the parts are to be received and is attached to the set of parts. Thus, at the sales hobs, a large amount of work has been required for comparing data on an enclosed tag with package specifications data and attaching a newly issued management tag to the parts when the parts are received from the brand manufacturer of vehicles.

Recently, thought of “supply chain management” has become a focus of attention for promptly responding to a change in the market, solving problems of “loss of sales opportunities” and “overstocked inventories” and improving cash flow efficiency in businesses. According to “supply chain management”, a flow of operations including acquisition, production, sales and distribution is managed as “supply chain”. If such “supply chain management” is introduced to the sales hubs, frequency of receiving parts will be increased and thus the above-mentioned work will be increased.

Japanese patent publications unexamined Nos. 11-53431, 11-165815 and 2001-282899 disclose prior art concerning distribution management for warehouses. However, the prior art disclosed in the publications does not contribute to reduction of an amount of work required when receiving parts at sales hubs.

So, there is a need for reduction of an amount of work required when receiving parts at the receiving side such as sales hubs.

### SUMMARY OF THE INVENTION

A parts distribution managing system for the sending side sending parts to the receiving side with a warehouse, according to the present invention comprises a device for managing data of locations in the warehouse, for the sending side, which is supplied with data indicating locations where parts are kept in the warehouse located at the receiving side to manage the data and a device for storing data of locations in the warehouse, for the sending side, which stores data of locations in the warehouse located at the receiving side. Further, the system comprises an enclosed-tag issuing device connected to the device for managing data of locations in the warehouse, for the sending side, which creates and issues an enclosed tag to be packed with parts, based on the data of locations in the warehouse, stored in the device for storing data of locations in the warehouse, for the sending side. The enclosed tag has at least a delivery number corresponding to a set of parts delivered according to an order and a location number indicating a location where the set of parts should be received in the warehouse located at the receiving side. Further, the system comprises a device for creating packing specifications data. The device is connected to the device for managing data of locations in the warehouse, for the sending side and creates packing specifications data, based on the data of locations in the warehouse, stored in the device for storing data of locations in the warehouse, for the sending side, to supply the packing specifications data to the receiving side. The packing specifications data include at least the delivery number and location number.

A parts distribution managing system for the receiving side with a warehouse receiving parts from the sending side, according to the present invention comprises a device for managing data of locations in the warehouse, for the receiving side, which manages data indicating locations where parts are kept in the warehouse located at the receiving side to supply the data to the sending side and a device for storing data of locations in the warehouse, for the receiving side, which stores data of locations in the warehouse located at the receiving side. Further, the system comprises a device for managing packing specifications data, which is supplied with packing specifications data by the sending side to manage the data and a device for storing packing specifications data, which stores packing specifications data. The packing specifications data include at least a delivery number corresponding to a set of parts delivered according to an order and a location number indicating a location where the set of parts should be received in the warehouse located at the receiving side. Further, the system comprises an enclosed-tag re-issuing device, which is connected with the device for storing data of locations in the warehouse, for the receiving side, and the device for storing packing specifications data. The enclosed-tag re-issuing device determines whether or not a location number included in packing specifications data is stored as that indicating an empty location, in the device for storing data of locations in the warehouse, for the receiving. The enclosed-tag re-issuing device re-issues another enclosed tag having a location number in the warehouse, corresponding to an empty location if the location number included in the packing specifications data is not stored as that indicating an empty location.

A parts distribution managing method in a system for the sending side sending parts to the receiving side with a warehouse, according to the present invention comprises the steps of receiving and then storing data of locations in the warehouse, indicating locations where parts are kept in the warehouse located at the receiving side, in a device for storing data of locations in the warehouse, for the sending side. Further, the method comprises the steps of creating and then issuing an enclosed tag to be packed with parts, based on the data of locations in the warehouse, stored in the device for storing data of locations in the warehouse, for the sending side. The enclosed tag has at least a delivery number corresponding to a set of parts delivered according to an order and a location number indicating a location where the set of parts should be received in the warehouse located at the receiving side. Further, the method comprises the steps of creating packing specifications data including at least the delivery number and location number and supplying the packing specifications data to the receiving side.

A parts distribution managing method in a system for the receiving side receiving parts from the sending side, according to the present invention comprises the steps of receiving packing specifications data from the sending side and then storing the packing specifications data in a device for storing packing specifications data. Further, the method comprises the steps of determining whether or not a location number included in the packing specifications data is stored as that indicating an empty location, in a device for storing data of locations in the warehouse, for the receiving side and re-issuing another enclosed tag having a location number in the warehouse, corresponding to an empty location if the location number included in the packing specifications data is not stored as that indicating an empty location. Further, the method comprises the steps of managing data indicating locations where parts are kept in the warehouse located at the receiving side to store the data of locations in the warehouse, in a device for storing data of locations in the warehouse, for the receiving side and supplying the data of locations in the warehouse, to the sending side.

An enclosed tag packed with parts, according to the present invention has a code indicating a delivery number corresponding to a set of parts delivered according to an order, a location number indicating a location where the set of parts should be received in a warehouse located at the receiving side and a code indicating the location number.

In the parts distribution managing system and the parts distribution managing method according to the present invention, an enclosed tag to be packed with parts, is issued. The enclosed tag has at least a delivery number corresponding to a set of parts delivered according to an order and a location number indicating a location where the set of parts should be received in the warehouse located at the receiving side. Further, packing specifications data including at least the delivery number and the location number are supplied to the receiving side. At the receiving side parts can be received in the warehouse using the enclosed tag and the packing specifications data, thus saving operators time and trouble. Further, when a location number in the packing specifications data does not indicate an empty location, a new enclosed tag may be re-issued for more flexible treatment.

According to a preferred embodiment of the present invention, the enclosed tag further has a code indicating a location number.

Further, at the receiving side locations in the warehouse are managed based on codes included in enclosed tags packed with parts.

Thus, data of locations in the warehouse, are managed for each enclosed tag, using a code included in the tag, allowing quicker update of inventory data and allocation of parts before reception.

### DESCRIPTION OF THE DRAWINGS

FIG. 1 shows a configuration of a parts-distribution management system according to an embodiment of the present invention;

FIG. 2 is a flowchart showing a method for managing parts distribution at the sending side according to an embodiment of the present invention;

FIG. 3 is a flowchart showing a method for managing parts distribution at the receiving side according to an embodiment of the present invention;

FIG. 4 shows data items of an enclosed tag according to an embodiment of the present invention; and

FIG. 5 shows data items of packing specifications data according to an embodiment of the present invention.

### DETAILED DESCRIPTION OF THE PREFERRED EMBODIMENTS

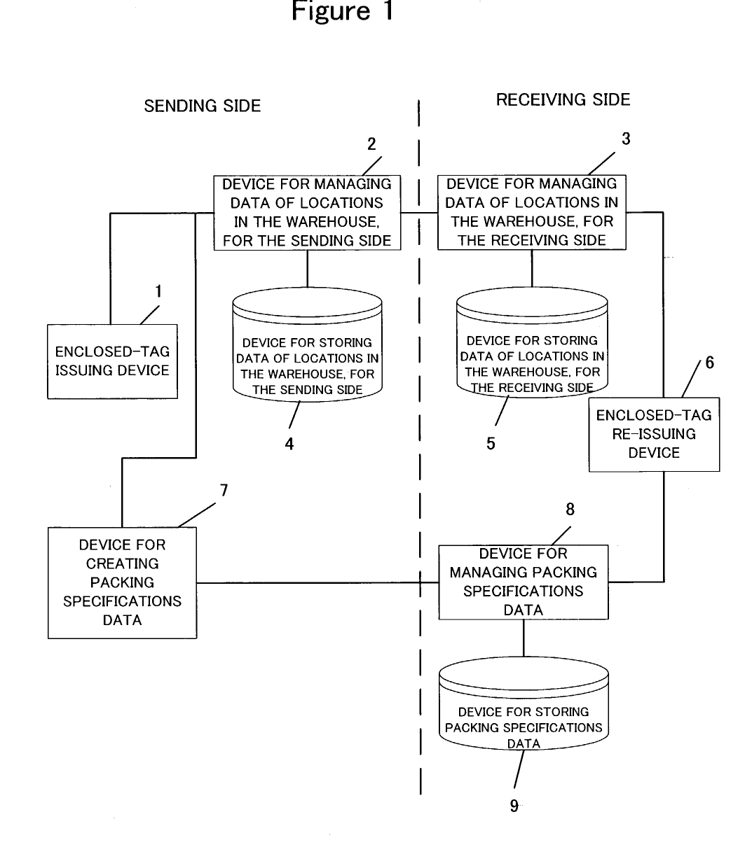

FIG. 1 shows a system configuration according to an embodiment of the present invention. An enclosed-tag issuing device is shown with reference numeral 1, which creates and issues an enclosed tag to be packed with parts. A device for managing data of locations in the warehouse, for the sending side, is shown with 2, which is supplied with and manages data of locations in the warehouse located at the receiving side. A device for storing data of locations in the warehouse, for the sending side, is shown with 4, which stores data of locations in the warehouse located at the receiving side. A device for creating packing specifications data is shown with 7, which creates packing specifications data. The above-mentioned devices function for the parts-sending side.

A device for managing data of locations in the warehouse, for the receiving side, is shown with reference numeral 3, which manages data of locations in the warehouse located at the receiving side to supply the data to the sending side. A device for storing data of locations in the warehouse, for the receiving side, is shown with 5, which sores data of locations in the warehouse located at the receiving side. A device for managing packing specifications data is shown with 8, which is supplied with packing specifications data by the sending side and manages them. A device for storing packing specifications data is shown with 9. An enclosed-tag re-issuing device is shown with 6, which is connected with the device for managing data of locations in the warehouse, for the receiving side, shown with 3 and the device for managing packing specifications data, shown with 8. The enclosed-tag re-issuing device determines whether or not a location number (address) included in packing specifications data is stored as that indicating an empty location, in the device for storing data of locations in the warehouse, for the receiving side, shown with 5. If the result is negative, the enclosed-tag re-issuing device re-issues another enclosed tag having a location number in the warehouse, corresponding to an empty location. The above-mentioned devices function for the parts-receiving side.

The enclosed-tag issuing device, shown with 1, the device for managing data of locations in the warehouse, for the sending side, shown with 2, the device for managing data of locations in the warehouse, for the receiving side, shown with 3, the enclosed-tag re-issuing device, shown with 6, the device for creating packing specifications data, shown with 7 and the device for managing packing specifications, shown with 8 may be realized as personal computers or workstations. Alternatively, they may be realized in mainframes. Although in FIG. 1 the above-mentioned devices are represented as separate ones, they may be realized as modules in a single computer such as those mentioned above. Further, devices functioning for the sending side and those functioning for the receiving side need not be located at the sending side and the receiving side, respectively, while the sending side and the receiving side are distant from each other. The devices at the sending side and those at the receiving side may preferably be connected via a private line. Alternatively, public lines provided with data security functions may be used. The both sides may be located in different countries.

The device for storing data of locations in the warehouse, for the sending side, shown with 4, the device for storing data of locations in the warehouse, for the receiving side, shown with 5 and the device for storing packing specifications data, shown with 9 may be realized as components including magnetic storage devices such as hard disks.

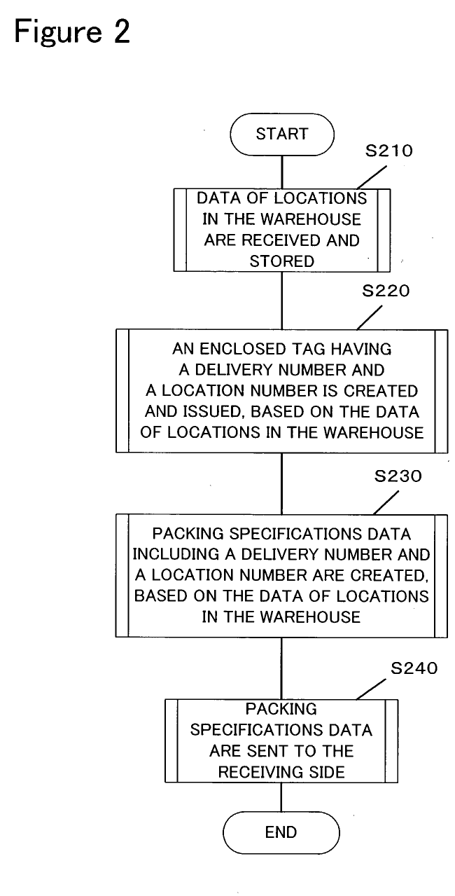

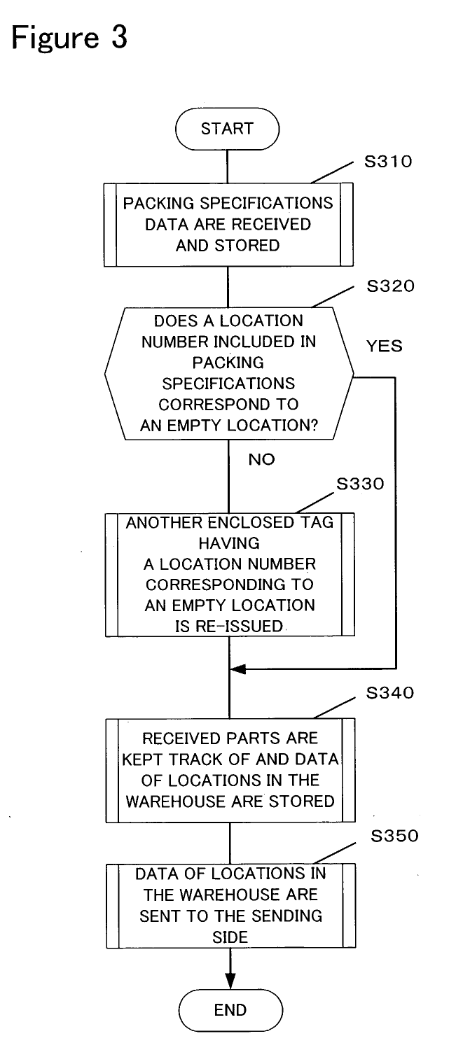

A method for managing parts distribution, performed by the above-mentioned system, will be described below based on FIGS. 2 and 3. FIG. 2 shows operations at the parts sending side and FIG. 3 shows operations at the parts receiving side.

At step S210 the device for managing data of locations in the warehouse, for the sending side, shown with 2 receives data of locations in the warehouse from the device for managing data of locations in the warehouse, for the receiving side, shown with 3 and stores the data in the device for storing data of locations in the warehouse, for the sending side, shown with 4.

At step S220 the enclosed-tag issuing device, shown with 1 creates and issues an enclosed tag, based on the data of locations in the warehouse, stored in the device for storing data of locations in the warehouse, for the sending side, shown with 4. An enclosed tag has a delivery number corresponding to a set of parts delivered according to an order and a location number indicating a location where the set of parts should be received in the warehouse located at the receiving side. An enclosed tag is packed with parts.

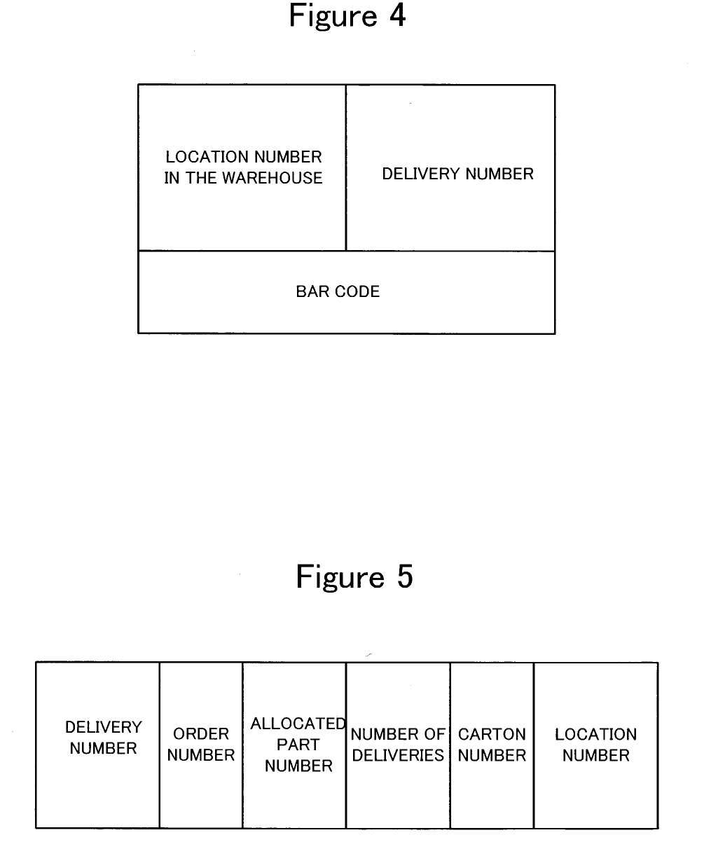

FIG. 4 shows data items of an enclosed tag. It should be noted that an enclosed tag has not only a delivery number corresponding to a set of parts delivered but also a location number indicating locations where the set of parts should be received. At the receiving side the parts can be received at the location in the warehouse, indicated by the location number shown on the enclosed tag. Accordingly, at the receiving side such operations as comparing data on an enclosed tag with package specifications data, creating a receiving list and creating and issuing a management tag for the warehouse, for the data for which the comparison has been successfully completed, become unnecessary. Further, machine-readable codes including one-dimensional or two-dimensional code such as bar code, representing a delivery number and a location number, may be printed on an enclosed tag.

At step S230 the device for creating packing specifications data, shown with 7, creates, based on data of locations in the warehouse, stored in the device for storing data of locations in the warehouse, for the sending side, shown with 4, to supply the created data to the receiving side. The packing specifications data include at least a delivery number and a location number. At step S240 the device for creating packing specifications data, shown with 7, sends the packing specifications data to the device for managing packing specifications data, shown with 8, for the receiving side, via a line such as a private line.

FIG. 5 shows data items in packing specifications data. Packing specifications data include not only a delivery number and a location number but also an order number, an allocated part number, number of deliveries, a carton number and the like.

Operations at the parts receiving side will be described below. At step S310 in FIG. 3 the device for managing packing specifications data, shown with 8, is supplied with packing specifications data by the sending side and stores them in the device for storing packing specifications data, shown with 9.

At step S320 the enclosed-tag re-issuing device, shown with 6 determines whether or not a location number included in packing specifications data is stored as that indicating an empty location, in the device for storing data of locations in the warehouse, for the receiving side. If the location number included in packing specifications data is not stored as that indicating an empty location, the enclosed-tag re-issuing device, shown with 6 re-issues another enclosed tag having a location number corresponding to an empty location at step S330. If the a location number included in packing specifications data is stored as that indicating an empty location, the enclosed-tag re-issuing device, shown with 6 does not re-issue another enclosed tag. The parts are received at locations in the warehouse, indicated by the enclosed tag issued by the device for creating packing specifications data, shown with 7.

It should be noted that the method according to the present invention, is able to flexibly cope with cases where data of locations at the sending side and those at the receiving side do not coincide with each other.

At step S340 the device for managing data of locations in the warehouse, for the receiving side, shown with 3, keeps track of received parts and stores data of locations in the warehouse, showing where the parts have been received, in the device for storing data of locations in the warehouse, for the receiving side, shown with 5. In order to keep track of received parts, such a code as a bar code indicated on an enclosed tag may be read when parts are received. In this case the device for managing data of locations in the warehouse, for the receiving side, shown with 3, must be provided with the function of reading a bar code. Thus, managing data of locations in the warehouse, for each enclosed tag allows quicker update of inventory data and allocation of parts before reception.

At step S350 the device for managing data of locations in the warehouse, for the receiving side, shown with 3, supplies data of locations in the warehouse, stored in the device for storing data of locations in the warehouse, for the receiving side, shown with 5, to the device for managing data of locations in the warehouse, for the sending side, shown with 2 via such a line as a private line. Data of locations in the warehouse may be sent to the sending side whenever any of data is updated. Alternatively, they may be sent when number of updates reaches a certain value or at regular intervals.

The present invention eliminates the need for issuing a new tag at the receiving side. At the receiving side parts can be received in the warehouse using an enclosed tag and packing specifications data, created by the sending side, thus saving operators time and trouble. Further, when a location number in the packing specifications data does not indicate an empty location, a new enclosed tag may be re-issued for more flexible treatment.

According to a preferred embodiment of the present invention, data of locations in the warehouse, are managed for each enclosed tag, using a code included in the tag, allowing quicker update of inventory data and allocation of parts before reception.

What is claimed is:

1. A parts distribution managing system for the sending side sending parts to the receiving side with a warehouse, comprising:
a device for managing data of locations in the warehouse, for the sending side, which is supplied with data indicating locations where parts are kept in the warehouse located at the receiving side, to manage the data;
a device for storing data of locations in the warehouse, for the sending side, which stores data of locations in the warehouse located at the receiving side;
an enclosed-tag issuing device connected to the device for managing data of locations in the warehouse, for the sending side, which creates and issues an enclosed tag to be packed with parts, based on the data of locations in the warehouse, stored in the device for storing data of locations in the warehouse, for the sending side, the enclosed tag having at least a delivery number corresponding to a set of parts delivered according to an order and a location number indicating a location where the set of parts should be received in the warehouse located at the receiving side; and
a device for creating packing specifications data which is connected to the device for managing data of locations in the warehouse, for the sending side and which creates packing specifications data, based on the data of locations in the warehouse, stored in the device for storing data of locations in the warehouse, for the sending side, to supply the packing specifications data to the receiving side, the packing specifications data including at least the delivery number and location number.

2. A parts distribution managing system according to claim 1 wherein the enclosed-tag issuing device creates and issues an enclosed tag further having a code indicating at least the location number.

3. A parts distribution managing system for the receiving side with a warehouse receiving parts from the sending side, comprising:
a device for managing data of locations in the warehouse, for the receiving side, which manages data indicating locations where parts are kept in the warehouse located at the receiving side to supply the data to the sending side;
a device for storing data of locations in the warehouse, for the receiving side, which stores data of locations in the warehouse located at the receiving side;
a device for managing packing specifications data, which is supplied with packing specifications data by the sending side to manage the data, the packing specifications data including at least a delivery number corresponding to a set of parts delivered according to an order and a location number indicating a location where the set of parts should be received in the warehouse located at the receiving side;
a device for storing packing specifications data, which stores packing specifications data; and
an enclosed-tag re-issuing device, which is connected with the device for storing data of locations in the warehouse, for the receiving side, and the device for storing packing specifications data, and which determines whether or not a location number included in packing specifications data is stored as that indicating an empty location, in the device for storing data of locations in the warehouse, for the receiving side and which re-issues another enclosed tag having a location number in the warehouse, corresponding to an empty location if the location number included in the packing specifications data is not stored as that indicating an empty location.

4. A parts distribution managing system according to claim 3 wherein the device for managing data of locations in the warehouse, for the receiving side manages data of locations in the warehouse, based on a code included in an enclosed tag packed with parts.

5. A parts distribution managing method in a system for the sending side sending parts to the receiving side with a warehouse, the method comprising the steps of:
receiving and then storing data of locations in the warehouse, indicating locations where parts are kept in the warehouse located at the receiving side, in a device for storing data of locations in the warehouse, for the sending side;
creating and then issuing an enclosed tag to be packed with parts, based on the data of locations in the warehouse, stored in the device for storing data of locations in the warehouse, for the sending side, the enclosed tag having at least a delivery number corresponding to a set of parts delivered according to an order and a location number indicating a location where the set of parts should be received in the warehouse located at the receiving side;
creating packing specifications data including at least the delivery number and location number; and
supplying the packing specifications data to the receiving side.

6. A parts distribution managing method according to claim 5, wherein the enclosed tag further has a code indicating at least the location number.

7. A parts distribution managing method in a system for the receiving side receiving parts from the sending side, the method comprising the steps of:
receiving packing specifications data from the sending side and then storing the packing specifications data in a device for storing packing specifications data;
determining whether or not a location number included in the packing specifications data is stored as that indicating an empty location, in a device for storing data of locations in the warehouse, for the receiving side;
re-issuing another enclosed tag having a location number in the warehouse, corresponding to an empty location if the location number included in the packing specifications data is not stored as that indicating an empty location;
managing data indicating locations where parts are kept in the warehouse located at the receiving side to store the data of locations in the warehouse, in a device for storing data of locations in the warehouse, for the receiving side; and
supplying the data of locations in the warehouse, to the sending side.

8. A parts distribution managing method according to claim 7, wherein the data of locations in the warehouse are managed based on a code included in an enclosed tag packed with parts.

9. An enclosed tag packed with parts, having a code indicating a delivery number corresponding to a set of parts delivered according to an order, a location number indicating a location where the set of parts should be received in a warehouse located at the receiving side and a code indicating the location number.
